(19) United States
(12) Patent Application Publication
(10) Pub. No.: US 2025/0145540 A1
(43) Pub. Date: May 8, 2025

(54) METHOD FOR CLOSING AN ORIFICE OF A SILICON CARBIDE-BASED CONTAINER

(71) Applicant: COMMISSARIAT A L'ENERGIE ATOMIQUE ET AUX ENERGIES ALTERNATIVES, Paris (FR)

(72) Inventors: Valérie CHAUMAT, Grenoble (FR); Philippe EMONOT, Gif-Sur-Yvette (FR); Christophe LORRETTE, Grenoble (FR); Valérie MERVEILLEAU, Grenoble (FR)

(73) Assignee: COMMISSARIAT A L'ENERGIE ATOMIQUE ET AUX ENERGIES ALTERNATIVES, Paris (FR)

(21) Appl. No.: 18/914,371

(22) Filed: Oct. 14, 2024

(30) Foreign Application Priority Data
Oct. 19, 2023 (FR) 2311333

(51) Int. Cl. C04B 41/45; C04B 35/565; C04B 35/80; C04B 41/00; C04B 41/50; C04B 41/87; G21F 5/008

(52) U.S. Cl. CPC C04B 41/4523; C04B 35/565; C04B 35/80; C04B 41/0081; C04B 41/457; C04B 41/4596; C04B 41/5059; C04B 41/87; G21F 5/008; C04B 2235/3826

(57) ABSTRACT

A method for closing an orifice of a container. The method involves first providing a silicon carbide-based container comprising a cavity that is open by an orifice, of a silicon carbide-based plug and of a brazing material borne by the plug and/or the container. A solid object is housed in the cavity. Then the orifice is closed by brazing the plug onto the container. The brazing involves the melting the brazing material followed by solidification of the brazing material so as to form a solid joint between the container and the plug. At least a part of the cavity, referred to as a cold part, in which the solid object is housed, is kept at a temperature lower than the degradation temperature of the solid object during the brazing.

### TECHNICAL FIELD

The present invention relates to the field of methods for assembling silicon carbide-based parts. In particular, the present invention relates to methods for closing an orifice of a silicon carbide-based container.

### PRIOR ART

Silicon carbide-based containers have mechanical and thermal properties that make them suitable for various applications, notably in the nuclear, aeronautical or space sector. For example, silicon carbide-based containers, in particular made of composite comprising silicon carbide fibers incorporated in a silicon carbide matrix, are envisioned as components in nuclear reactors of the future. Notably, they can contribute to containing and protecting nuclear fuel pellets while promoting heat exchanges. Such containers can also be used in heat exchangers, gas turbines or tanks.

In order to close silicon carbide-based containers, it is known for the opening orifice of the container to be filled by a plug. Depending on the envisioned application, it is desired for the closure to also have good mechanical and thermal properties. It is thus advantageous for the plug to also be based on silicon carbide. It may also be necessary for the plug to be securely joined to the container in such a way as to be resistant to high temperatures.

However, the customary methods that allow two silicon carbide-based parts to be securely joined together often require integral heating of said parts to high temperatures. These methods are therefore not suitable for closing a silicon carbide-based container housing an object that deteriorates at said high temperatures.

Patent application US 2021/0166825 A1 describes a method for forming a fluid-tight joint between a silicon carbide structure and a plug having a central opening in order to fill the structure with gas during the method. However, this method is complex to implement. There is therefore a need for a closure of a silicon carbide-based container that is robust and resistant to high temperatures, and that is simple to implement and ensures the physical integrity and the performance of an object enclosed in the container.

### SUMMARY OF THE INVENTION

The invention aims to at least partially meet this need and proposes a method for closing an orifice of a container, the method comprising the following successive steps:
a) provision of a silicon carbide-based container comprising a cavity that is open by the orifice, of a silicon carbide-based plug and of a brazing material borne by the plug and/or the container, a solid object being housed in the cavity,
b) closure of the orifice by brazing of the plug onto the container, the brazing comprising the melting of the brazing material by heating to a temperature greater than the melting temperature of the brazing material, followed by solidification of the brazing material so as to form a solid joint between the container and the plug, at least a part of the cavity, referred to as cold part, in which the solid object is housed, being kept at a temperature lower than the degradation temperature of the solid object during the brazing.

The method according to the present invention is simple, rapid to implement and does not degrade the mechanical and thermal properties of the container. In addition, since the brazing according to the invention requires only a localized supply of heat, the cold part of the cavity remains at a temperature that ensures the physical integrity, including the geometrical shape, of any object that deteriorates at high temperatures, for example at temperatures greater than 800° C., which could be disposed in the cavity. Furthermore, the closure obtained by the method according to the invention is advantageously robust, fluid-tight, resistant to oxidation and resistant to temperatures ranging at least up to temperatures close to, but strictly less than, the melting temperature of the brazing material, typically up to 50° C. below the melting temperature of the brazing material, for example up to 1200° C., or even 1300° C., or even 1400° C.

A “silicon carbide-based” part is made of a material comprising at least 50% by mass of silicon carbide.

“The degradation temperature of the solid object” corresponds to the highest temperature at which the physical integrity of the object is maintained, that is to say at which the object does not deform substantially under its own weight and/or does not undergo any change in physical state, for example a phase change, and/or is not altered by a chemical reaction, and/or its mechanical properties, notably its creep strength, are not reduced. Preferably, the degradation temperature of the solid object is equal to 0.5 times, or even 0.4 times, the melting temperature of said object.

Preferably, the solid object comprises at least one nuclear fuel pellet. Preferably, the gas tightness of the solid object is ensured by the presence of a metal liner made of zirconium alloy.

Preferably, the cold part is kept at a temperature lower than 800° C. during the brazing.

Preferably, the container is made of sintered monolithic silicon carbide or of a composite comprising ceramic fibers incorporated in a silicon carbide matrix, the ceramic fibers preferably being made of silicon carbide or of carbon. Preferably, the container is made of a composite comprising silicon carbide fibers incorporated in a silicon carbide matrix.

Preferably, the container is of hollow cylindrical shape, one of the ends of the cylinder being open by the orifice, the end of the cylinder on the opposite side from the orifice being closed.

Preferably, the cold part represents at least 70%, or even at least 80%, or even at least 90%, of the volume of the cavity.

Preferably, the cavity extends along a longitudinal axis (X) and the cold part extends over at least 70%, or even at least 80%, or even at least 90%, of the length of the cavity along the longitudinal axis (X).

Preferably, the cavity extends along a longitudinal axis (X) and the joint formed by the brazing extends over at least 0.1% of the length of the cavity along the longitudinal axis (X), preferably over between 0.1% and 10%, or even between 0.1% and 5%, of the length of the cavity along the longitudinal axis (X).

Preferably, the distance between the plug and the cold part during the brazing is less than or equal to 10 mm, preferably less than 5 mm, preferably between 2 and 5 mm.

Preferably, the heating is carried out by induction by a susceptor arranged in the vicinity of the orifice. Preferably, at least one thermal insulator is arranged between the susceptor and the cold part of the cavity. Advantageously, the heat is confined to the zone where the plug is brazed onto the container during step b). Induction heating shortens the heating duration during step b).

Preferably, during step b), the duration of the heating of the brazing material to a temperature greater than the melting temperature of the brazing material is between a few seconds and 20 minutes, preferably between 30 seconds and 5 minutes.

Preferably, the heating temperature for the brazing material during the melting thereof in step b) is greater than or equal to 1250° C., or even greater than or equal to 1300° C., or even greater than or equal to 1400° C.

Preferably, the brazing material is heated to a temperature lower than or equal to 1850° C., or even to a temperature lower than 1600° C., during the brazing. If the container and the plug are made of sintered monolithic silicon carbide, the heating temperature for the brazing material may be between 1600° C. and 1850° C. during the brazing. If at least one of the container and the plug is made of a composite comprising ceramic fibers incorporated in a silicon carbide matrix, the heating temperature for the brazing material is preferably lower than 1600° C. during the brazing.

Preferably, during step b), the solidification of the brazing material comprises gradual cooling of the brazing material at a cooling rate of between 1 and 50 K/min.

Preferably, the method comprises the cooling, during the brazing, of the cold part by a cooling system extending along at least a portion of the cold part, said portion comprising the end of the cold part adjacent to the heating zone for the brazing material. Preferably, the cooling system comprises a fluidic circuit in which a cooling fluid circulates during the brazing.

Preferably, the plug is made of sintered monolithic silicon carbide or of a composite comprising ceramic fibers incorporated in a silicon carbide matrix, the ceramic fibers preferably being made of silicon carbide or of carbon. Preferably, the plug is made of a composite comprising silicon carbide fibers incorporated in a silicon carbide matrix.

Preferably, the plug is formed of the same material as the container.

Preferably, the plug provided in step a) comprises at least one cutout filled with the brazing material. Advantageously, this ensures a sufficient supply of brazing material during the brazing, the cutout or cutouts each forming a reservoir of brazing material which may take the form for example of holes filled with brazing material.

Preferably, at least a part of the brazing material is borne by the plug, the closure step b) being preceded by a step of heating the plug and the brazing material borne by the plug to a temperature greater than the melting temperature of the brazing material, preferably to a temperature greater than or equal to 1250° C., or even greater than or equal to 1300° C., or even greater than or equal to 1400° C., during which the brazing material melts, and then by a step of solidifying the brazing material. Preferably, the plug and the brazing material borne by the plug are placed in an environment under vacuum or under inert gas during the heating of the plug and of the brazing material borne by the plug. Preferably, the inert gas is argon or helium. Preferably, the heating of the plug and of the brazing material borne by the plug is carried out to a temperature lower than or equal to 1850° C., or even to a temperature lower than 1600° C., during the brazing. If the plug is made of sintered monolithic silicon carbide, the heating temperature for the brazing material may be between 1600° C. and 1850° C. during the brazing. If the plug is made of a composite comprising ceramic fibers incorporated in a silicon carbide matrix, the heating temperature for the brazing material is preferably lower than 1600° C. during the brazing.

Advantageously, this prior heating of the plug and of the brazing material borne by the plug distributes the brazing material homogeneously on the plug before the brazing so as to obtain a good supply of the brazing material during the brazing.

If the plug is a composite comprising ceramic fibers incorporated in a silicon carbide matrix, this prior heating also induces an infiltration of the brazing material in the liquid state, during the melting thereof, into the porosities of the plug. Thus, after the solidification step, the solidified brazing material covers the surface of the plug and at least partially, or even completely, fills the porosities of the plug. Advantageously, such an infiltration of the brazing material into the plug improves the thermal diffusivity, the tightness and the mechanical strength of the plug impregnated with brazing material.

Preferably, the container, the plug and the brazing material are placed in an environment under inert gas or under vacuum throughout the closure step b), or under vacuum for one part of step b) and under inert gas for the other part of step b), the inert gas preferably being argon or helium. Advantageously, this limits the undesirable reactions during the brazing.

An “environment under vacuum” is an environment with a pressure lower than 10⁻¹ Pa. The environment may be placed under higher vacuum, for example with a pressure of between 10⁻³ Pa and 10⁻⁵ Pa.

According to a first variant, during step a), the brazing material is in the form of a brazing paste comprising a binder and a brazing powder dispersed in the binder. Preferably, the brazing powder comprises a silicon alloy or a silicide or a mixture of silicon and silicide or a mixture of silicides or an oxide or a mixture of oxides. Preferably, the binder is an aqueous gel. Preferably, the binder has an evaporation temperature lower than 500° C., or even lower than 400° C., preferably close to 300° C. Advantageously, such a brazing material is not reactive or not very reactive with the silicon carbide and therefore does not degrade the mechanical and thermal properties of the container and the plug during the method.

According to a second variant, during step a), the brazing material is in the form of a multitude of solid granules. Preferably, the granules comprise a silicon alloy or a silicide or a mixture of silicon and silicide or a mixture of silicides or an oxide or a mixture of oxides.

According to a third variant, during step a), the brazing material is in the form of at least one sheet wrapped around the plug. Preferably, the sheet comprises a silicon alloy or a silicide or a mixture of silicon and silicide or a mixture of silicides or an oxide or a mixture of oxides.

According to a fourth variant, during step a), the brazing material is in the form of a coating deposited, prior to step a), on the outer periphery of the plug and/or on the inner wall of the container, by physical vapor deposition or by chemical vapor deposition. Such a deposition enables better control of the thickness of the coating. The chemical vapor deposition may be plasma-enhanced chemical vapor deposition or may be atomic layer deposition. Preferably, the coating comprises a silicon alloy or a silicide or a mixture of silicon and silicide or a mixture of silicides or an oxide or a mixture of oxides.

Preferably, the silicon alloy or the silicide is composed of silicon and at least one element selected from among chromium, cobalt, cerium, titanium, vanadium, zirconium, neodymium, praseodymium, ruthenium, rhodium, rhenium, yttrium, iridium, nickel, platinum, palladium, silver, aluminum, molybdenum and tungsten. Preferably, the silicon alloy or the silicide comprises at least 50 at. % of silicon. Preferably, the element is zirconium or chromium. Preferably, the silicon alloy or the silicide comprises between 90% and 42% by mass of silicon and between 10% and 58% by mass of zirconium.

Preferably, the oxide is selected from among silicon dioxide, alumina, calcium oxide, magnesium oxide and the mixtures thereof.

Preferably, the brazing material also comprises carbon particles and/or silicon carbide particles.

Preferably, during step b), carbon particles and/or silicon carbide particles are disposed in the form of powder in the clearance between the container and the plug.

Advantageously, the presence of carbon particles and/or silicon carbide particles in the brazing material and/or in the clearance between the container and the plug has the result that the joint formed by solidification of the brazing material is a composite comprising silicon carbide. If silicon carbide particles are involved, the silicide or the oxide of the brazing material infiltrates in liquid phase, during the brazing, between the silicon carbide particles such that the joint formed by solidification of the brazing material is a composite comprising silicon carbide particles. If carbon particles are involved, the silicon alloy or the silicide of the brazing powder reacts with the carbon particles during the brazing such that the joint formed by solidification of the brazing material comprises silicon carbide.

Other advantages and features will emerge more clearly on reading the detailed description, which is given by way of non-limiting illustration, with reference to the figures below.

### BRIEF DESCRIPTION OF THE DRAWINGS

FIG. 1 is a schematic depiction in front view of a silicon carbide container comprising an orifice open at one of its ends.

FIG. 2 is a schematic depiction in front view of the container according to FIG. 1, a plug being inserted in the orifice.

FIG. 3 is a schematic depiction in front view of the container according to FIG. 1, a plug being inserted in the orifice and a brazing paste being borne by the plug and the container.

FIG. 4 is a schematic depiction in front view of the container, the plug and the brazing paste according to FIG. 3 being subjected to localized heating at the end comprising the orifice.

FIG. 5 is a schematic depiction in front view of a silicon carbide container comprising an orifice at one of its ends, the orifice being plugged by a plug brazed to the container.

FIGS. 6 to 8 are schematic depictions in front view of a plug bearing the brazing paste.

FIG. 9 is a schematic depiction in front view of a plug comprising cutouts filled with brazing material.

FIG. 10 is a schematic depiction in longitudinal section of an example of a device for implementing the method according to the invention, by localized heating.

FIG. 11 is a graph showing the measured and simulated changes in the temperature of a container at the orifice thereof and of a susceptor over time during a heating cycle for a brazing operation of the method according to the invention, the graph also showing the change in the electrical power feeding the coil over time during said heating cycle.

FIG. 12 is a schematic depiction in longitudinal section of a mechanical test during which a pushing force is applied to a plug closing the orifice of a container, the closure being obtained by a method according to the present invention.

FIG. 13 is a graph showing the change in the pushing force as a function of the displacement of the load applying the pushing force measured during the mechanical test illustrated in FIG. 12.

### DETAILED DESCRIPTION

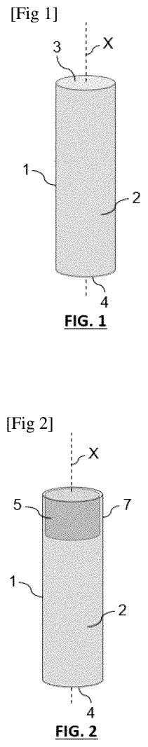

FIGS. 1 to 5 illustrate an example of implementation of the method according to the invention. The method comprises a step a) of provision of a container 1, of a plug 5 and of a brazing material 6 borne by the container 1 and/or the plug 5. FIGS. 1 to 3 show different sub-steps of an example of implementation of step a).

FIG. 1 illustrates an example of a container 1. The container has a hollow cylindrical shape extending along a longitudinal axis X. It comprises a cavity 2 extending along the longitudinal axis X, for example over a length of between 5 and 400 cm. The cavity 2 is open at one of the ends of the container 1 by an orifice 3, the other end 4 of the container 1 being closed. A solid object is housed in the cavity 2 of the container 1. The orifice 3 can have an opening diameter of between 0.5 and 50 cm. The container 1 is based on silicon carbide, preferably made of a composite comprising silicon carbide fibers incorporated in a silicon carbide matrix.

FIG. 2 illustrates the placement of a plug 5 in the cavity 2. The plug 5 is of complementary shape to the cavity 2 at the orifice 3 so as to be inserted therein with a small clearance, the clearance preferably being less than 100 μm, such that the plug 5 remains immobile when inserted in the orifice 3. It then has a small gap between the wall 7 of the container 1 and the plug 5. The joint formed between the plug 5 and the container 1 at the end of the method according to the invention will then have a small thickness, and this is advantageous mechanically. For example, the plug 5 is a cylinder of revolution, having a diameter of between 0.4 and 5 cm. Once inserted in the container 1, the plug 5 extends along the longitudinal axis X, for example over a length of between 0.5 and 5 cm. Notably, when the plug 5 is inserted in the container 1, it occupies between 0.1 and 10% of the length of the cavity 2, measured along the longitudinal axis X. The plug 5 is based on silicon carbide, preferably made of a composite comprising silicon carbide fibers incorporated in a silicon carbide matrix.

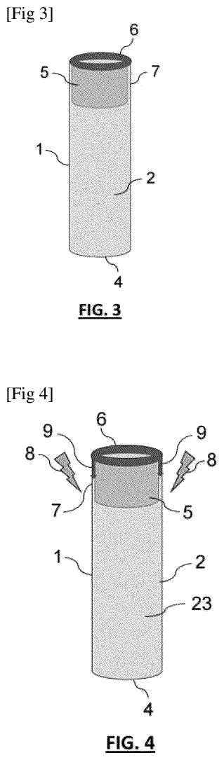

Then, the brazing material 6 is deposited, in the form of a paste, on the plug 5 and/or on the wall 7. FIG. 3 illustrates the container 1 with the plug 5 inserted in the orifice 3 and the brazing paste 6 deposited on the plug 5 and on the wall 7. The present invention is not limited to a brazing material 6 deposited in the form of a paste, and other forms of brazing material and deposition methods are conceivable, for example the brazing material may be in the form of a multitude of granules or a sheet or a coating as described above.

Step a) is followed by a step b) of closure of the orifice 3 by brazing of the plug 5 onto the container 1. To this end, heating is carried out in a localized manner at the orifice 3 so as to heat the plug 5, the wall 7 close to the orifice 3 and the brazing material 6 to a temperature greater than 1250° C., or even greater than 1300° C., or even greater than 1400° C. FIG. 4 illustrates said localized heating, the lightning bolts 8 symbolizing the targeted supply of heat. The localized heating melts the brazing material 6, which infiltrates into the gap between the plug 5 and the wall 7. The melting and infiltration of the brazing material 6 is symbolized by arrows 9. If the container 1 and/or the plug 5 are made of a composite comprising ceramic fibers incorporated in a silicon carbide matrix, then the brazing material 6 infiltrates into the porosities of the container 1 and/or of the plug 5.

During the localized heating, a part of the cavity 2, referred to as cold part 23, at a distance from the heating zone is kept at a temperature lower than 800° C. The cold part 23 extends over at least 70% of the length of the cavity 2 along the longitudinal axis X. Notably, the cold part 23 corresponds to the entirety of the cavity 2 that is at least 1 cm, preferably at least 5 mm, preferably at least 2 mm, away from the plug 5 inserted in the orifice 3.

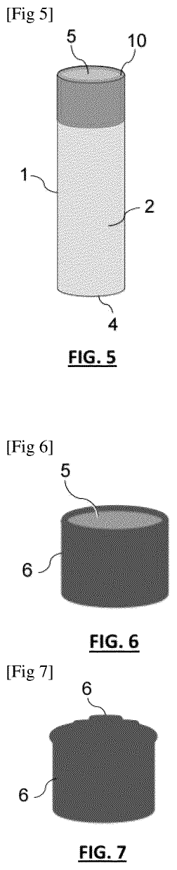

After the heating, the plug 5, the container 1 and the brazing material 6 are cooled. The brazing material 6 is solidified during the cooling thereof, thus forming a solid joint 10 between the plug 5 and the wall 7, as is shown in FIG. 5. The orifice 3 is thus plugged by the plug 5 fastened to the container 1 by brazing.

According to another example of implementation, the plug 5 provided in step a) at least partially bears the brazing material 6 before it is inserted in the container 1. Then, the plug 5 is inserted with the brazing material 6 into the orifice 3. This is followed by the step b) of closure of the orifice 3.

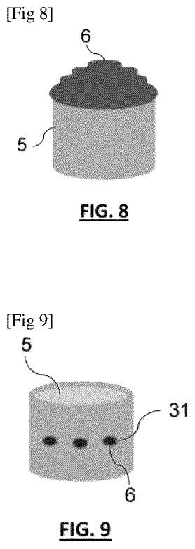

FIGS. 6, 7 and 8 illustrate different methods for depositing the brazing material 6 on the plug 5. For example, the brazing material 6 may be deposited on and borne by the lateral surface of the plug 5, the bases of the plug 5 not being covered with the brazing material 6, as illustrated in FIG. 6. As an alternative, the brazing material 6 may be deposited on and borne by the lateral surface of the plug 5 and the upper base of the plug 5, as illustrated in FIG. 7. As an alternative, the brazing material 6 may be deposited on and borne by the upper base of the plug 5, the lateral surface of the plug 5 not being covered with brazing material 6, as illustrated in FIG. 8.

Furthermore, the plug 5 may also comprise at least one cutout 31 filled with brazing material 6, as illustrated in FIG. 9. The cutouts 31 thus form reservoirs of brazing material 6, thus increasing the supply of brazing material 6 during the brazing in step b). For example, the cutouts 31 may be blind holes recessed into the lateral wall of the plug 5. The cutout or cutouts 31 may also be radial grooves or slots.

Prior to the insertion of the plug 5 and in step b), the brazing material 6 borne by the plug 5 can be heated to a temperature greater than the melting temperature thereof. The brazing material 6 then flows so as to cover at least the lateral surface of the plug 5, or even the entire plug 5. The heating may be carried out in a furnace, preferably under high vacuum or under inert gas, the inert gas preferably being argon or helium. Then, a solidification of the brazing material 6 by cooling is carried out after said heating. Thus, the solidified brazing material 6 is uniformly distributed over the plug 5, ensuring a good supply of the brazing material 6 during the brazing of the plug 5 onto the container 1.

If the plug 5 is made of a composite comprising ceramic fibers incorporated in a silicon carbide matrix, this prior heating also induces an infiltration of the brazing material into the porosities of the plug 5, followed by solidification upon cooling. Such an infiltration improves the thermal diffusivity, the tightness and the mechanical strength of the plug 5 impregnated with brazing material 6.

The inventors have carried out tensile tests at ambient temperature in order to compare the differences in mechanical behavior between a tensile test specimen that is not impregnated with brazing material 6 and a tensile test specimen whose porosities have been infiltrated by the brazing material 6. The tensile test specimens were all made of a composite comprising silicon carbide fibers in a silicon carbide matrix. The tensile test specimens were 75 mm-long cylindrical test specimens with a central section having a diameter of 9.50 mm. The brazing material 6 used was in the form of a paste comprising a powder, made up of a silicon alloy composed of 88% by mass of silicon and 12% by mass of zirconium, mixed with an aqueous gel as binder. In the tensile tests, a breaking stress of the order of 240 MPa, for a deformation of the order of 0.8 to 0.9%, was measured for the non-impregnated tensile test specimen. A breaking stress of the order of 280 MPa, for a deformation greater than 1.1%, was measured for the tensile test specimen whose porosities had been infiltrated by the brazing material 6. These tensile tests therefore show a significant improvement in the mechanical strength of the tensile test specimen when it is impregnated with brazing material 6.

If the brazing material 6 is not distributed sufficiently uniformly over the plug 5 after the heating, an additional deposition of brazing material 6 on the plug 5, notably on the zones lacking brazing material 6, may be carried out. This deposition is preferably followed by an additional heating of the plug 5 and of the brazing material 6 borne by the plug 5, similarly to the preceding paragraph. Where appropriate, this additional deposition advantageously fills in the disparities in the coverage of the brazing material 6 on the plug 5 that are caused by the infiltration of the brazing material 6 into the porosities of the plug 5.

Machining may be carried out subsequent to the solidification of the brazing material 6 on the plug 5 in order to reduce the asperities formed by the brazing material 6 on the plug 5. Advantageously, this facilitates the insertion of the plug 5 into the container 1. In addition, once the orifice 3 has been closed by the plug 5, the latter has few, or even no, asperities on its surface facing the object housed in the cavity. If the brazing material 6 were in the form of a coating deposited, prior to step a), by physical vapor deposition, or by chemical vapor deposition, it is not beneficial to carry out the aforementioned machining because the asperities are negligible.

Moreover, the container 1 provided in step a) may also bear at least a part of the brazing material 6 before the insertion of the plug 5 within it. Notably, the brazing material 6 may cover that portion of the wall 7 onto which the plug 5 will be brazed.

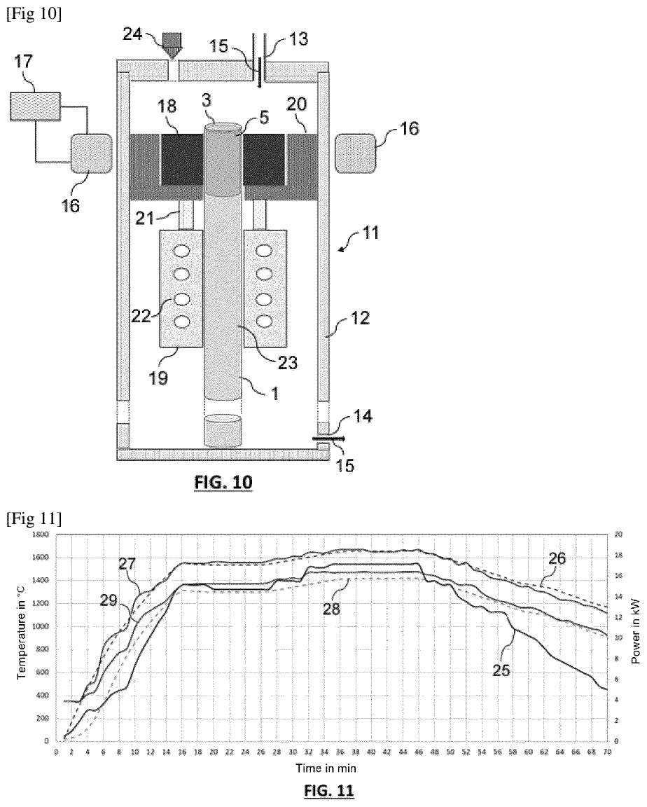

FIG. 10 illustrates a device 11 configured to carry out the heating of the brazing material in step b) of the method according to the present invention. The device 11 comprises a hermetic enclosure 12 for housing the container 1 with the plug 5 inserted in the orifice 3 and the brazing material 6 borne by the plug 5 and/or the container 1. Preferably, the enclosure 2 is a quartz tube.

A feed line 13 leads into the enclosure 12. The feed line 13 is adapted to inject an inert gas within the enclosure 12. The inert gas may be argon or helium. The device 11 comprises a discharge line 14 for discharging the gases present in the enclosure 12. This line 14 can also make it possible to create the vacuum in the enclosure 12. Preferably, the feed line 13 and the discharge line 14 are configured such that the inert gas circulates continuously in the enclosure 12.

The device 11 also comprises a coil 16 comprising at least one turn around the enclosure 12. Preferably, the turn or turns are made of copper. The coil 16 is electrically connected to a high-frequency generator 17. A susceptor 18 is housed in the enclosure 12 and encircled by the coil 16. Preferably, the susceptor 18 is made of graphite. The susceptor 18 comprises a central passage for accommodating the container 1 housed in the enclosure 12, the susceptor 18 then surrounding the container 1 in the region of the orifice 3 and the plug 5. Preferably, the coil 16 and the susceptor 18 are concentric such that the central passage of the susceptor 18 is centered in the middle of the coil 16.

The device 11 also comprises a cooling system 19 arranged in the enclosure 12 so as to extend along the cold part 23 of the container 1. Notably, the cooling system 19 may comprise a central passage into which the container 1 is inserted, such that the cooling system 19 faces the cold part 23 over the entire length thereof. Preferably, the cooling system 19 comprises a fluidic circuit winding around the passage that accommodates the container 1, a cooling fluid, preferably water, being intended to circulate in the fluidic circuit. Preferably, the ducts 22 of the fluidic circuit are made of copper or of brass.

It is not necessary for the cooling system 19 to extend over the entire length of the cold part 23. The cold part 23 may comprise a portion remote from the heating zone such that it is not significantly affected by the heating during step b), that is to say that it would remain at ambient temperature even without cooling. Where appropriate, it is not necessary for the cooling system 19 to extend along the aforementioned remote portion. Moreover, a first thermal insulator 20 is arranged between the wall of the enclosure 12 and the susceptor 18 and between the susceptor 18 and the cooling system 19. Preferably, the first thermal insulator 20 is made of insulating graphite, for example of fibrous graphite. In addition, a second thermal insulator 21 is arranged between the first thermal insulator 20 and the cooling system 19. The second thermal insulator 21 may be made of oxide, for example of alumina.

The heating carried out by the device 11 is localized and inductive heating. First of all, the container 1 is placed in the enclosure 12 with the plug 5 inserted in the orifice 3 and the brazing material 6 borne by the plug 5 and/or by the container 1. Once the container 1 has been placed, the susceptor 18 surrounds the wall 7 in the region of the orifice 3, the plug 5 and the brazing material 6, and the cooling system 19 extends along the cold part 23.

Then, the inert gas is injected into the enclosure 12. The vacuum may be created in the enclosure 12 prior to the injection of the inert gas. Preferably, the injection of the inert gas is such that the enclosure 12 is at atmospheric pressure. Preferably, the inert gas is injected through the feed line 13 and then discharged through the discharge line 14 so as to maintain a continuous circulation of the inert gas in the enclosure 12. The direction of circulation of the inert gas in the enclosure 12 is shown by the arrows 15.

Thereafter, the cooling system 19 is activated for cooling the cold part 23. Notably, a cooling fluid, preferably water, can be circulated in the fluidic circuit.

Then, the high-frequency generator 17 feeds electrical power to the coil 16, which then generates a magnetic field. The susceptor 18 converts, by induction, the energy from the magnetic field into heat, and this heats, by conduction and in a localized manner, the wall 7 of the container 1 in the region of its orifice 3, the plug 5 and the brazing material 6. The electrical power fed by the high-frequency generator 17 is gradually increased so as to gradually increase the heating temperature up to at least 1250° C., or even at least 1300° C., or even at least 1400° C. During the heating by conduction, the first and second thermal insulators 20 and 21 confine the heat produced by the susceptor 18 to the zone where the plug 5 is being brazed onto the container 1, thus increasing the localization of the heating. During the heating, the cooling system 19 continuously cools the cold part 23, which is kept at a temperature lower than 800° C.

Thus, the device 11 illustrated in FIG. 10 makes it possible to carry out the step b) of closure of the orifice 3 by brazing of the plug 5 onto the container 1. The device 11 locally heats, by induction, the brazing material 6 borne by the plug 5 and/or by the container 1 and melts said brazing material 6 in order to braze the plug 5 onto the container 1. Furthermore, the device 11 keeps the cold part 23 at low temperature during the heating. The keeping at low temperature is achieved by thermal insulation between the cold part 23 and the zone where the plug 5 is being brazed onto the container 1 and by cooling of the cold part 23 by the cooling system 19.

The inventors have carried out simulations and measurements in order to determine the change in temperatures involved during a brazing operation of the method according to the invention over time. To this end, the device 11 comprises a pyrometer 24 measuring the temperature of the susceptor 18 and the temperature of the container 1 in the region of the orifice 3. The device 11 also comprises a thermocouple (not shown here) measuring the temperature of the susceptor 18 and the temperature of the container 1 in the region of the orifice 3. The measurements carried out by the pyrometer 24 have been compared with the measurements carried out by the thermocouple. FIG. 11 illustrates the results of these simulations and of these measurements. The simulations and the measurements have been carried out for a heating cycle during which the mean electrical power feeding the coil 16 reaches a first level at 15 kW for 10 minutes and then a second level at 17 kW for 10 minutes. The curve 25 shows the change in the mean electrical power feeding the coil 16 during the heating cycle.

The curve 26 shows the change in the simulated temperature of the susceptor 18 during the heating cycle. The curve 27 shows the change in the measured temperature of the susceptor 18 during the heating cycle. The curves 26 and 27 show that the susceptor 18 reaches a temperature of 1560° C. during the first level and then a temperature of 1620° C. during the second level.

The curve 28 shows the change in the simulated temperature of the container 1 in the region of the orifice 3 during the heating cycle. It shows that the temperature of the container 1 in the region of the orifice 3 reaches a temperature of 1300° C. during the first level and then a temperature of 1420° C. during the second level. The curve 29 shows the change in the measured temperature of the container 1 in the region of the orifice 3 during the heating cycle. The curve 29 shows that the temperature of the container 1 in the region of the orifice 3 reaches a temperature of 1320° C. during the first level and then a temperature of 1480° C. during the second level. Thus, the simulated or measured temperature of the container 1 in the region of the orifice 3 during each of the first and second levels is greater than or equal to 1300° C., as desired for the brazing in step b) of the method according to the invention.

The inventors have also simulated the change in the temperature of the cold part 23 during the heating cycle described above. The maximum temperature of the cold part 23 obtained by this simulation is 725° C. This temperature is therefore well below 800° C.

The inventors have tested the mechanical strength of a closure obtained according to the present invention. To this end, they closed a container 1 using the method according to the present invention. The container 1 and the plug 5 provided were made of composite comprising silicon carbide fibers incorporated in a silicon carbide matrix. The brazing material 6 used was in the form of a paste comprising a powder, made up of silicon alloy composed of 88.5% by mass of silicon and 11.5% by mass of zirconium, mixed with an aqueous gel, for example the gel “Vitta Braz-Binder Gel Grade ST” or the cement “Nicrobraz” which are commercially available, as binders. Approximately 400 mg of the brazing paste 6 was deposited on the plug 5. The plug 5 and the brazing paste 6 borne by the plug were then heated under argon in a brazing furnace to 1420° C. so as to melt the brazing material 6 which completely covered the plug 5 and filled a cutout recessed into the plug 5. The brazing material 6 borne by the plug 5 was then solidified by cooling and machining was carried out to eliminate the asperities that were formed by the brazing material 6 on the plug 5 and were liable to impede the insertion of the plug 5 into the container 1. Subsequently, the plug 5 was brazed onto the container 1 in order to close the orifice 3 of the container 1. The brazing was carried out in the device 11 illustrated in FIG. 10 as explained above. The brazing comprised heating the wall 7 of the container 1 in the region of its orifice 3, the plug 5 and the brazing material 6 to a temperature of 1420° C. for 10 minutes followed by gradual cooling of the brazing material 6.

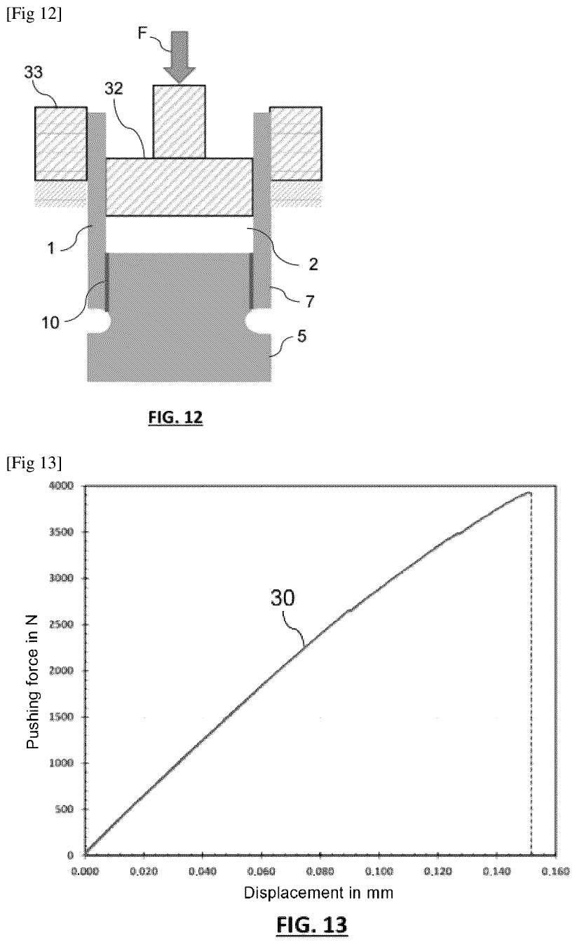

To test the robustness of the closure of the container 1 obtained according to the preceding paragraph, the inventors carried out a mechanical test, of the “pull-out” type, as illustrated in FIG. 12. This mechanical test comprises the application of a pushing force F to the plug 5 with the aid of a piston 32 in order to generate a shear stress at the joint 10 between the plug 5 and the wall 7, the container 1 being borne by a frame 33 during the mechanical test.

FIG. 13 illustrates the result of this mechanical test. The curve 30 shows the pushing force F as a function of the displacement of the piston 32 during this mechanical test. The maximum pushing force applied before breakage of the closure is 3925 N. The closure of the container 1 therefore has a breaking strength of 221 MPa, a nominal shear strength of 30.4 MPa and a burst pressure of 736 bar. Moreover, the breakage did not occur at the joint 10, rather it is the wall 7 of the container 1 beyond the joint 10 which broke. Thus, the joint 10 formed by the method according to the present invention is stronger than the container 1.

Other variants and improvements may be envisioned without thereby departing from the scope of the invention as defined by the claims below.

1. A method for closing an orifice of a container, the method comprising, in order:
a) providing a silicon carbide-based container comprising a cavity that is open by an orifice, of a silicon carbide-based plug, and of a brazing material borne by the plug and/or the container, a solid object being housed in the cavity,
b) brazing the plug onto the container to close the orifice, the brazing comprising melting of the brazing material by heating to a temperature greater than the melting temperature of the brazing material, followed by solidification of the brazing material so as to form a solid joint between the container and the plug, at least a part of the cavity, referred to as a cold part, in which the solid object is housed, being kept at a temperature lower than the degradation temperature of the solid object during the brazing,
the brazing further comprising cooling of the cold part by a cooling system extending along at least a portion of the cold part, the portion of the cold part comprising an end of the cold part adjacent to a heating zone for the brazing material.

2. The method of claim 1, wherein the solid object comprises at least one nuclear fuel pellet.

3. The method of claim 1, wherein the container is made of a sintered monolithic silicon carbide or a composite comprising ceramic fibers incorporated in a silicon carbide matrix.

4. The method of claim 1, wherein the container has a hollow cylindrical shape, one of the ends of the cylinder being open by the orifice, and
wherein the end of the cylinder on the opposite side from the orifice is closed.

5. The method of claim 1, wherein the cold part is at least 70% of the volume of the cavity.

6. The method of claim 1, wherein the distance between the plug and the cold part during the brazing is less than or equal to 10 mm.

7. The method of claim 1, wherein the heating is carried out by induction by a susceptor arranged in the vicinity of the orifice.

8. The method of claim 1, wherein the brazing material is heated to a temperature greater than or equal to 1250° C. during the brazing.

9. The method of claim 1, wherein the brazing material is heated to a temperature lower than or equal to 1850° C.

10. The method of claim 1, wherein the cooling system comprises a fluidic circuit in which a cooling fluid circulates during the brazing.

11. The method of claim 1, wherein the plug is made of sintered monolithic silicon carbide or is made of a composite comprising ceramic fibers incorporated in a silicon carbide matrix.

12. The method of claim 1, wherein the plug provided in a) comprises a cutout filled with the brazing material.

13. The method of claim 1, wherein at least a part of the brazing material is borne by the plug, the brazing b) being preceded by:
heating the plug and the brazing material borne by the plug to a temperature greater than the melting temperature of the brazing material during which the brazing material melts and
solidifying the brazing material.

14. The method of claim 1, wherein the container, the plug, and the brazing material are placed in an environment under vacuum or under inert gas throughout the closure b), or under vacuum for one part of b) and under inert gas for the other part of b).

15. The method of claim 1, wherein during a), the brazing material is in the form of a brazing paste comprising a binder and a brazing powder dispersed in the binder.

16. The method of claim 1, wherein during a), the brazing material is in the form of a multitude of solid granules.

17. The method of claim 1, wherein during a), the brazing material is in the form of at least one sheet wrapped around the plug.

18. The method of claim 1, wherein during a), the brazing material is in the form of a coating deposited, prior to a), on the outer periphery of the plug and/or on the inner wall of the container, by physical vapor deposition or by chemical vapor deposition.
